(19) United States
(12) Patent Application Publication
(10) Pub. No.: US 2022/0135255 A1
(43) Pub. Date: May 5, 2022

(54) SPACE SURVEILLANCE ORBIT

(71) Applicant: Raytheon Company, Waltham, MA (US)

(72) Inventor: David C. Langill, Redondo Beach, CA (US)

(21) Appl. No.: 17/087,996

(22) Filed: Nov. 3, 2020

(51) Int. Cl. B64G 1/24; B64G 1/10

(52) U.S. Cl. CPC B64G 1/242; B64G 1/105; B64G 2001/1028; B64G 2001/1057; B64G 1/1021

(57) ABSTRACT

A satellite system includes a satellite in an orbit that is configured to reduce a number of exclusion regions and improve the observation coverage of resident space objects (RSOs) positioned in near Earth orbits. The satellite system includes at least one satellite positioned in a sun synchronous orbit (SSO) with a noon/midnight nodal crossing. The altitude of the SSO is between 1000 and 2000 kilometers and the satellite includes at least one sensor arranged on the satellite that is configured for detection, tracking, and/or identification. Using the noon/midnight nodal crossing is advantageous in that three main exclusion regions, the sun, eclipse, and Earth exclusion regions, are combined into only two exclusion regions for improved performance of the satellite system in observing RSOs.

### FIELD OF THE DISCLOSURE

The disclosure generally relates to satellites, and more particularly, to systems and methods for tracking objects in space.

### DESCRIPTION OF THE RELATED ART

Various military, civil, commercial and intelligence applications use space situational awareness (SSA) to perform detection, tracking, identification, and characterization of Resident Space Objects (RSOs) located in Earth orbits including low Earth orbit (LEO), medium Earth orbits (MEO) and a geosynchronous or geostationary Earth orbit (GEO). For example, the SSA application may be used to detect new objects, verify a position and velocity of existing objections, locate objects that have been moved, and capture imagery of the objects. This information may be used to avoid collisions in space, provide threat warning and assessment, evaluate the conditions of the RSOs, characterize space weather environmental effects, and determine the operating status of satellites. The SSA mission objective is to provide coverage of all RSOs in Earth orbits with a rapid revisit rate so that the RSO can be accurately tracked and monitored. Conventional SSA satellite systems use space-based and/or ground-based radar, and/or electro-optical sensors to detect and track RSOs in space.

There are several current and prior space based SSA satellite systems implemented with satellites that have optical sensors in a sun synchronous orbit (SSO) which are synchronized with the sun and have a nodal regression rate equal to the Earth's mean orbital rate around the sun. Accordingly, a satellite in SSO is synchronous with the sun such that the orbital plane of the satellites is in a fixed orientation relative to the sun. There are unique orbital altitudes for SSO orbits which result in a repeating ground track which are beneficial in that they pass over a location on the ground at the same time every day enabling Earth imaging sensors to have repeating coverage of an area of interest. Another benefit of the SSO is the sun orientation with respect to the orbital plane is constant which simplifies the satellite solar array and thermal subsystem arrangements. The prior SSA satellite systems have utilized an SSO with a dawn/dusk orbit in which the satellite rides along the day/night terminator line. This approach is deficient in that the LEO/MEO/GEO coverage of RSOs may be limited and revisit rates may be slow due to three primary exclusion regions in which RSOs may be unobservable and system performance is degraded.

Conventional SSA satellites have three primary exclusion regions. One of the exclusion regions is a sun exclusion region in which the SSA electro-optical sensors looks near to or directly at the sun such that the sensor is saturated and the sensor performance is diminished. Another exclusion region is an eclipse exclusion region in which the Earth is between the RSO and the sun, such that sunlight cannot be reflected off the RSO. Thus, there is no inflow of reflected energy to the SSA electro-optical sensors during the eclipse resulting in poor target detection. Still another exclusion region is an Earth exclusion region in which the RSO is hidden by the Earth and the SSA electro-optical sensors cannot see the RSO.

### SUMMARY OF THE DISCLOSURE

The present disclosure provides a satellite system using an electro-optical sensors that has a unique orbit which reduces the number of exclusions regions and improve the observation coverage time and revisit rate of resident space objects (RSOs) positioned in low Earth orbits (LEOs), medium Earth orbits (MEOs) and geosynchronous Earth orbits (GEOs), as compared with conventional satellite systems. According to a general embodiment, the satellite system includes at least one satellite positioned in a sun synchronous orbit (SSO) with an approximately noon/midnight orbit, where the local mean solar time of passage for equatorial latitude is around noon or midnight, or within 45 degrees of noon or midnight. The altitude of the SSO is between 1000 and 2000 kilometers and the satellite includes at least one sensor arranged on the satellite that is configured for detection, tracking, and/or identification. There is a unique orbital altitude, 1680 kilometers, within this SSO orbital altitude range which provides a repeating ground track. The SSA satellite in this configuration could perform multiple missions and be equipped with two electro-optical sensors which could track RSOs in orbit and provide Earth imaging data.

Using the noon/midnight orbit is advantageous in that the previous three exclusion regions, i.e. the sun, eclipse, and Earth exclusion regions, are approximately combined into two exclusion regions. This is achieved by the Earth and the eclipse exclusion regions being combined in a same portion of the GEO belt when the satellite is in the sunlight portion of the SSO, and by the Earth and the sun exclusion regions being combined in a same portion of the GEO belt when the satellite is in the eclipse portion of the SSO. The sun/earth exclusion zone can be reduced with a sensor system which uses a sun shade to reduce the sun exclusion angle which will improve the SSA coverage. Thus, the Earth exclusion region is effectively combined with the other exclusion zones. The higher SSO altitude also improves coverage of the satellite system in that the angular extent of the Earth exclusion region decreases with increasing orbit altitude. In exemplary embodiments, the altitude may also be slightly below the peak radiation levels of inner Van Allen belt to avoid a higher radiation environment.

The satellite system provides improved coverage of the RSOs in that a percentage of time in a day in which the RSO is observed by the satellite is increased as compared with conventional satellite systems due to a reduction of the exclusion regions. Accordingly, a revisit rate for an RSO, or the number of times the RSO is viewed in a day, by the satellite system is increased. For example, the RSO may be monoscopically observed by the satellite for an average of 71 percentage of the day. The satellite system with two or more satellites may have a stereoscopic mode where the system has more than one viewpoint of an RSO. The percentage of stereoscopic coverage for the satellite is between 40 and 80% depending on the number of satellites in the system, which is higher than the stereoscopic coverage rates of conventional satellite systems.

According to an aspect of the disclosure, a satellite system includes at least one satellite positioned in a sun synchronous orbit having a noon/midnight orbit and arranged at an altitude that is between 1000 and 2000 kilometers.

According to an aspect of the disclosure, a satellite system includes at least one satellite positioned in an orbit in which an Earth exclusion zone is combined with other exclusion zones.

According to an aspect of the disclosure, the satellite system is configured for stereoscopic observation of RSOs with two or more satellites.

According to an aspect of the disclosure, a method of observing RSOs in space includes reducing an area or number of exclusion regions in which the RSOs are unobservable.

According to an aspect of the disclosure, a method of observing RSOs in space includes increasing the revisit rate of an RSO by a satellite.

According to an aspect of the disclosure, a satellite system includes at least one satellite positioned in a sun synchronous orbit having a midnight or noon local time of ascending or descending node, or a local time of ascending or descending node that is within 45 degrees of midnight or noon, and an altitude that is between 1000 and 2000 kilometers, and at least one sensor arranged on at least one satellite and configured to observe resident space objects in an Earth orbit.

According to an embodiment in accordance with any paragraph(s) of this summary, the sun synchronous orbit has fewer than three main exclusion regions in which resident space objects are unobservable.

According to an embodiment in accordance with any paragraph(s) of this summary, the sun synchronous orbit has two exclusion regions including an Earth/eclipse exclusion region in which an Earth exclusion region and an eclipse exclusion region are in a same portion of an Earth orbit belt, and including an Earth/sun exclusion region in which the Earth exclusion region and a sun exclusion region are in a same portion of the Earth orbit belt.

According to an embodiment in accordance with any paragraph(s) of this summary, the satellite system includes two or more satellites.

According to an embodiment in accordance with any paragraph(s) of this summary, the two or more satellites have altitudes that are between 1000 and 2000 kilometers.

According to an embodiment in accordance with any paragraph(s) of this summary, the altitude of the at least one satellite is 1680 kilometers whereby the satellite system is configured to have a repeating ground track.

According to an embodiment in accordance with any paragraph(s) of this summary, an inclination of the sun synchronous orbit is greater than 90 degrees.

According to an embodiment in accordance with any paragraph(s) of this summary, a percentage of time in a day in which the RSO in a geosynchronous orbit is monoscopically observed by the at least one satellite is greater than 63 percent.

According to an embodiment in accordance with any paragraph(s) of this summary, the SSA system includes more than one satellite enabling the system to provide a stereoscopic mode in which the more than one satellite have a viewpoint.

According to an embodiment in accordance with any paragraph(s) of this summary, the system with four satellites provides coverage for a percentage of time in a day in which the RSO is stereoscopically observed which is greater than 80.

According to an embodiment in accordance with any paragraph(s) of this summary, the sensor is a visible sensor and/or an infrared sensor.

According to another aspect of the disclosure, a method of observing resident space objects using a satellite system includes generating commands to at least one satellite positioned in a sun synchronous orbit having a midnight or noon local time of ascending or descending node, or a local time of ascending or descending node that is within 45 degrees of midnight or noon, and an altitude that is between 1000 and 2000 kilometers. The method includes generating commands to a sensor arranged on the at least one satellite to selectively observe resident space objects in an Earth orbit.

According to an embodiment in accordance with any paragraph(s) of this summary, the method includes observing the resident space objects with the at least one satellite in the sun synchronous orbit having fewer than three main exclusion regions in which space objects are unobservable.

According to an embodiment in accordance with any paragraph(s) of this summary, the method includes eliminating an Earth exclusion region by combining the Earth exclusion region with the eclipse exclusion region in the same portion of the Earth's orbit belt. The method also includes eliminating the Earth exclusion region by combining with the Sun exclusion region of the Earth's orbital belt.

According to an embodiment in accordance with any paragraph(s) of this summary, the method includes increasing the revisit rate of the at least one satellite for the resident space objects.

According to an embodiment in accordance with any paragraph(s) of this summary, the method includes monoscopically observing the resident space objects in the sun synchronous orbit for over 70% of time in a day.

According to an embodiment in accordance with any paragraph(s) of this summary, the method includes stereoscopically observing the resident space objects in the sun synchronous orbit for over 80% of time in a day.

According to an embodiment in accordance with any paragraph(s) of this summary, the method includes detecting and/or imaging the resident space objects using a visible or infrared sensor.

According to an embodiment in accordance with any paragraph(s) of this summary, the method includes pointing at least one electro-optical imaging sensor at the Earth, pointing at least one electro-optical sensor at space, and performing situational space awareness and Earth imaging with a sun synchronous orbit having approximately a noon/midnight nodal crossing and a repeating ground track with an altitude of 1680 kilometers.

According to still another aspect of the disclosure, a method of forming a satellite system includes arranging at least one sensor on a satellite to observe resident space objects in an Earth orbit, and launching the satellite into a sun synchronous orbit having a midnight or noon local time of ascending or descending node, that is within 45 degrees of midnight or noon nodal crossing, and an altitude that is between 1000 and 2000 kilometers, wherein the sun synchronous orbit has fewer than three main exclusion regions in which resident space objects are unobservable.

To the accomplishment of the foregoing and related ends, the disclosure comprises the features hereinafter fully described and particularly pointed out in the claims. The following description and the annexed drawings set forth in detail certain illustrative embodiments of the disclosure. These embodiments are indicative, however, of but a few of the various ways in which the principles of the disclosure may be employed. Other objects, advantages and novel features of the disclosure will become apparent from the following detailed description of the disclosure when considered in conjunction with the drawings.

### BRIEF DESCRIPTION OF DRAWINGS

The annexed drawings, which are not necessarily to scale, show various aspects of the disclosure.

FIG. 1 shows a conventional satellite system in a dawn/dusk sun synchronous orbit (SSO) for observing a resident space object (RSO) in an orbit that has three exclusion regions in which the RSO is unobservable.

FIG. 2 shows another conventional satellite system for observing RSOs in a dawn/dusk orbit.

FIG. 3 shows a satellite system according to the present application that includes at least one satellite positioned in an SSO having a noon/midnight orbit and an altitude that is between 1000 and 2000 kilometers, and only two exclusion regions in which the RSOs are unobservable.

FIG. 4 shows a graph illustrating the percentage of time in a day in which the satellite system of FIG. 3 is able to observe RSOs in geosynchronous Earth orbit (GEO) during solstice season as a function of the altitude of the SSO.

FIG. 5 shows an exemplary embodiment of the satellite system of FIG. 3 in which the SSO has an altitude of 1500 during an equinox.

FIG. 6 shows the satellite system of FIG. 5 during a solstice.

FIG. 7 shows a graph illustrating the percentage of time in a day in which the satellite system of FIGS. 5 and 6 is able to observe RSOs at GEO throughout the duration of a year.

FIG. 8 shows another exemplary embodiment of the satellite system of FIG. 3 in which the SSO has an altitude of 2000 kilometers.

FIG. 9 shows still another exemplary embodiment of the satellite system of FIG. 3 in which the satellite has two SSO satellites that have stereo coverage of an RSO.

FIG. 10 shows still another exemplary embodiment of the satellite system of FIG. 3 in which three SSO satellite have simultaneous coverage of an RSO.

FIG. 11 shows still another exemplary embodiment of the satellite system of FIG. 3 in which four SSO satellite have simultaneous coverage of an RSO.

FIG. 12 shows a flowchart illustrating a method of observing RSOs in space.

FIG. 13 shows a flowchart illustrating a method of forming a satellite system, such as the satellite system shown in FIG. 3.

### DETAILED DESCRIPTION

The principles described herein have particular application in space situational awareness (SSA) systems and more specifically, to systems and methods for observing Resident Space Objects (RSOs). Observing RSOs includes detection, tracking, identification, imaging for characterization, tactical warning, and attack assessment, by a satellite system with an electro-optical sensor in a sun synchronous orbit (SSO) with a noon/midnight orbit. The principles described herein are applicable to military, civil, commercial and intelligence applications that use satellite systems for various functions. Tracking of space debris for collision avoidance, anti-satellite countermeasures, monitoring space weather effects, tracking near Earth orbit objects for impact predictions, space defense, and foreign satellite warfare may all be suitable applications.

Any suitable satellite may be implemented in the satellite system described herein. The satellite system may include any sensor arrangement as dependent on a specific application for the satellite system, such as a specific mission. Any suitable launch vehicle may be used to insert a satellite into the SSO described herein. Many different combinations of satellites, sensors, and launch vehicles may be used with the satellite system described herein. The space situational awareness (SSA) system described herein is a surveillance system and the performance of the system can be characterized by the parameters of coverage and revisit time. The coverage is defined as the percentage of time that the SSA satellite has a view of the RSO. The revisit time is time elapsed between observations of the RSO, i.e. the time it takes to revisit the RSO. The system is configured to increase the percentage coverage and reduce the revisit time while minimizing the system resources and/or cost required to achieve the desired performance.

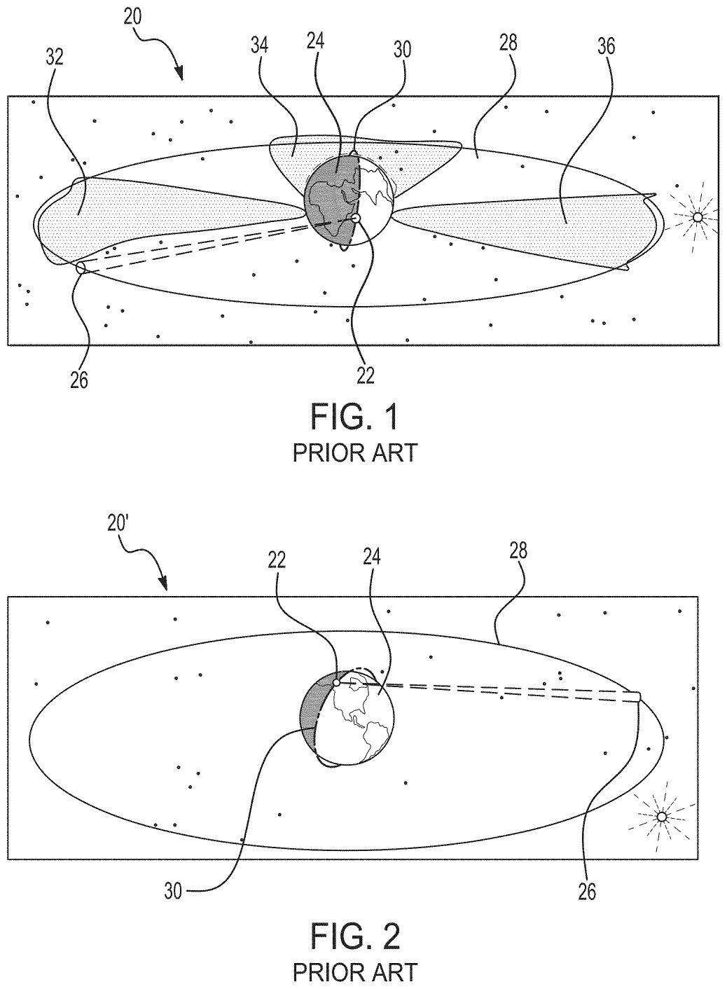

Referring first to FIGS. 1 and 2, conventional satellite systems 20, 20′ for performing SSA are shown. For example, the SSA satellite system 20 is an existing Sapphire system and the SSA satellite system 20′ is an existing Space-Based Visible Sensing System (SBSS). The SSA satellite systems 20, 20′ are in an SSO with a dawn/dusk configuration. An SSA satellite 22 of the satellite system 20, 20′ is used to locate RSOs 26, such an RSO satellite, orbiting the Earth 24. The RSOs may include satellites, debris, rocket bodies, etc. Each of the satellite systems 20, 20′ has at least one SSA satellite 22 positioned in an orbit 30. The orbit 30 is a low Earth orbit (LEO) having an altitude between 600 and 800 kilometers, such that the orbit 30 is relatively close to the Earth 24 as compared with other orbits.

The RSO satellite 26 is in a geosynchronous or geostationary orbit (GEO) 28 which is an orbit in the plane of the equator. The RSO satellite 26 rotates at the same rate as the Earth resulting in the RSO satellite 26 remaining stationary over a fixed point on the Earth. This orbit is beneficial for communication and meteorological satellites. Coverage of this orbit by the SSA satellite system 20, 20′ is an important mission for the SSA satellite system due to the large number of satellites in the GEO 28.

The conventional SSA satellite systems 20, 20′ having the SSA satellite 22 in SSO have a near-circular dawn-to-dusk orbit 30. In the dawn-to-dusk orbit, the SSA satellite 22 travels along the day/night terminator line, such that the light of the sun is always on the same surface of the SSA satellite 22. This orbit simplifies the satellite solar array and thermal system arrangements. The SSA satellite system 20 of FIG. 1 includes the orbit 30 having an altitude of approximately 786 kilometers and an inclination of 98.6 degrees, and the SSA satellite system 20′ of FIG. 2 includes the orbit 30 having an altitude of 630 kilometers and an inclination of 97.9 degrees.

However, the conventional SSA satellite systems 20, 20′ are disadvantageous in coverage of the RSOs 26. As shown in FIG. 1, the GEO 28 has three exclusion regions 32, 34, 36 in which RSOs 26 cannot be observed by the SSA satellite 22. In the eclipse exclusion region 32, the Earth 24 is positioned between the RSO satellite 26 and the sun, such that sunlight cannot be reflected off the RSO and the RSO is in the Earth's shadow, reducing an electro-optical signature of the RSO, resulting in RSO coverage outages in the Earth shadow. In the Earth exclusion region 34, the SSA satellite 22 looks near to or directly at the Earth which blocks the view of the RSO satellite 26, resulting in an outage in the coverage of the RSO satellite 26. In the sun exclusion region 36, the SSA satellite 22 electro-optical sensor boresight looks near to or directly at the sun such that the sensor is saturated and the sensor performance is diminished. The sun irradiance significantly reduces the ability for the sensor to detect RSO satellites 26 in the sun exclusion zone resulting in the third outage of coverage of the RSO satellite 26.

In view of the three exclusion regions 32, 34, 36, the SSA satellite system 20, 20′ is able to observe an RSO 26 for only about 53 percent of the day and the satellite system 20′ is able to observe an RSO 26 for only about 59 percent of the day. The SSA satellite system 20 has coverage outages 14 times per day for an RSO 26. The SSA satellite system 20′ has coverage outages 10 times per day. The gaps in coverage result in more coverage outages, increased revisit durations, and provides degraded performance compared to the satellite system according to the present application which only has 8 coverage outage per day and up to 75% coverage. Accordingly, the conventional SSA satellite systems 20, 20′ may not provide adequate coverage of the RSOs 26 for a particular mission or application.

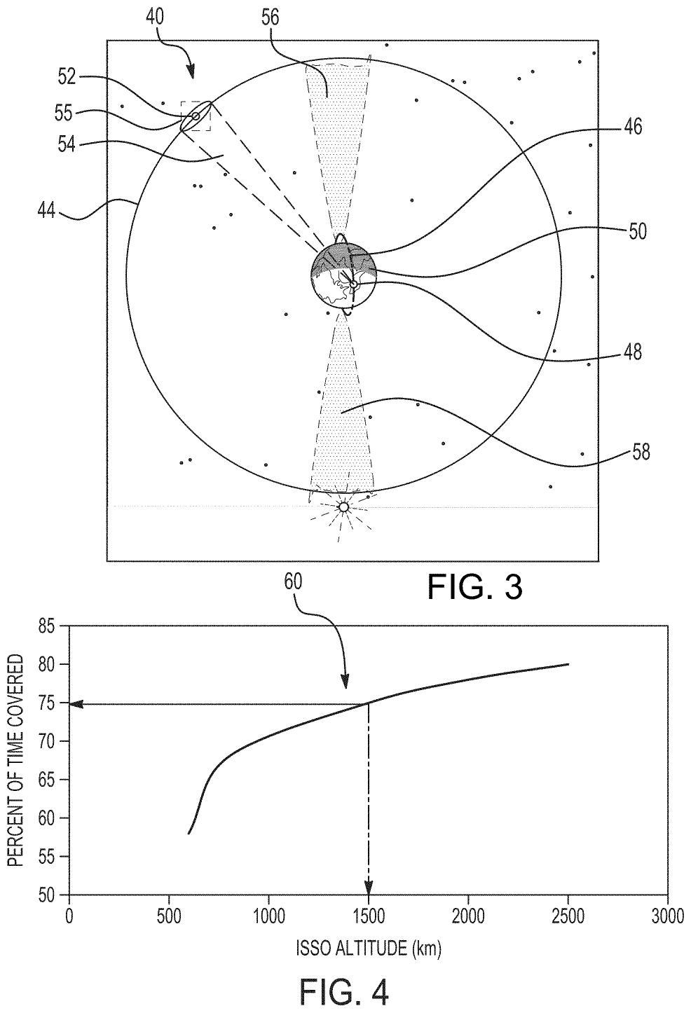

Referring now to FIG. 3, an SSA satellite system 40 according to the present application is shown. As compared with the conventional SSA satellite systems 20, 20′ shown in FIGS. 1 and 2, the SSA satellite system 40 is advantageous in that the SSA satellite system 40 maximizes observation coverage of the RSOs and minimizes the time required to revisit an RSO. The SSA satellite system 40 may be configured to observe RSOs in GEO 44. In other exemplary embodiments, the SSA satellite system 40 may also be configured to observe RSOs that are in LEO or in middle Earth orbit (MEO). The SSA satellite system 40 includes an SSO 46 in which at least one SSA satellite 48 is positioned. The SSO 46 has a noon/midnight orbit, or an orbit within 45 degrees of noon or midnight. Accordingly, the SSA satellite 48 crossing the equator of the Earth 50 heading north or south at noon or midnight will have an orbital plane aligned parallel with the vector from the satellite to the sun. This enables the SSA satellite 48 to see an entire arc of the GEO 44 to the left or right of the SSO 46.

The SSA satellite 48 is configured to observe RSOs 52 that are in GEO 44 around the Earth 50 (or in LEO or in MEO). A sensor 54 with a field of view (FOV) 55 is arranged on the SSA satellite 48 and configured to detect, track, and identify the RSOs 52, including imaging the RSO 52. A target RSO 52 moves across the FOV 55 of the sensor 54. The SSA satellite system 40 may be configured to provide near constant access to one or more US-based ground station for reporting of data using a combination of Free Space Optics (FSO) crosslinks to communication satellites or direct RF downlink to ground entry points.

Space-based SSA architectures are the preferred approach and have better resiliency as compared to ground based systems. Ground based systems can provide SSA observations of space based RSOs based on RADAR and/or EOIR sensor systems from ground based mobile or fixed locations. Ground based EOIR systems have limitations due to radar range limitations, EOIR weather outages, and EOIR systems only operate at night due to daylight outages caused by stray light scattering. The ground based systems have a limited FOV of the near Earth orbits due to the region of space above the ground based asset. The ground based systems require several ground based assets located around the globe. The global locations of the ground based systems can be defeated by military attacks and have poor resiliency. In contrast, space based assets have higher resiliency than ground based assets. The space based SSA satellites could be attacked by Anti-Satellite (ASAT) weapons. The SSA satellite system 40 according to the present application is at a higher altitude as compared to previous systems. The orbit altitude of the SSA satellite system 40 increases the ASAT flight time and gives the SSA satellite system 40 more time to take an evasive maneuvers, thereby increasing the resiliency as compared to conventional SSA space and/or ground systems.

More than one sensor 54 may be provided and any suitable sensor arrangement may be used. The sensor 54 may include electro optical sensors which detect electromagnetic radiation. Sensors 54 that are configured to detect infrared, visible, and ultraviolet, portions of the electromagnetic spectrum may be suitable. Depending on the type of sensor 54 and configuration of the SSA satellite system 40, the target RSO 52 may or may not require illumination by the sun. The type of sensor 54 may be selected to detect RSOs 52 having a specific size, which may be dependent on the application. Many different sensor types and configurations are possible.

The altitude of the SSO 46 is between 1000 and 2000 kilometers, such that the altitude is higher than conventional satellite systems having altitudes less than 800 kilometers. The altitude of the SSO 46 may be selected to be lower than the peak radiations levels of the lower radiation belt, also known as the lower Van Allen belt. The Van Allen radiation belt which occurs at altitudes between 1000 and 12,000 kilometers with the peak radiation levels occurring at 4000 km. Arranging the SSO 46 at an altitude that is less than 4000 kilometers, such as at around 1500 kilometers, may be particularly advantageous to avoid the damage to the satellite electronics which can occur at higher radiation environments provided by the Van Allen belt.

The SSO 46 having the noon/midnight orbit is used to reduce the three exclusion regions shown in FIG. 1 to two exclusion regions 56, 58, as shown in FIG. 3, by effectively eliminating the Earth exclusion region. The first exclusion region 56 is the Earth/eclipse exclusion region and the second exclusion region 58 is the Earth/sun exclusion region. When the SSA satellite 48 is in a sunlight portion of the SSO 46, the Earth exclusion region and the eclipse exclusion region are in a same portion of the GEO 44 such that the regions are overlapping in a single region. Similarly, when the SSA satellite 48 is in the eclipse portion of the SSO 46, the Earth exclusion region and the sun exclusion region are in a same overlapping portion of the GEO 44. This geometry is enabled by the altitude and the sun synchronous noon/midnight orbit configuration of the SSO 46. The higher altitude improves the coverage performance since the angular extent of the Earth exclusion region (as shown in FIG. 1) decreases as the altitude increases. Thus, the SSA satellite system 40 provides a unique orbit having optimal geometry for detection of the RSOs 52.

Referring in addition to FIG. 4, due to the elimination of the third exclusion region and increased altitude, the performance of the SSA satellite system 40 is increased as compared with conventional satellite systems. FIG. 4 shows a percentage of time in a day in which the SSA satellite system 40 is able to observe RSOs 52 in GEO 44 as a function of altitude for the SSA satellite system 40. The SSA satellite system 40 is also referred to as an improved space surveillance orbit (ISSO). For example, at an altitude of 1500 kilometers, which is below the peak radiation levels of the Van Allen belt, the SSA satellite system 40 may have a coverage percentage of around 75%. In contrast, the conventional satellite system having a dawn/dusk orbit at 800 kilometers may have a coverage percentage of 57%. The SSA satellite system 40 has only 8 outage regions for an RSO in GEO during equinox season and the conventional satellite systems has 14 outage regions during equinox. The lower number of outages enables the SSA satellite system 40 to have a faster revisit rate and improved performance compared to conventional systems.

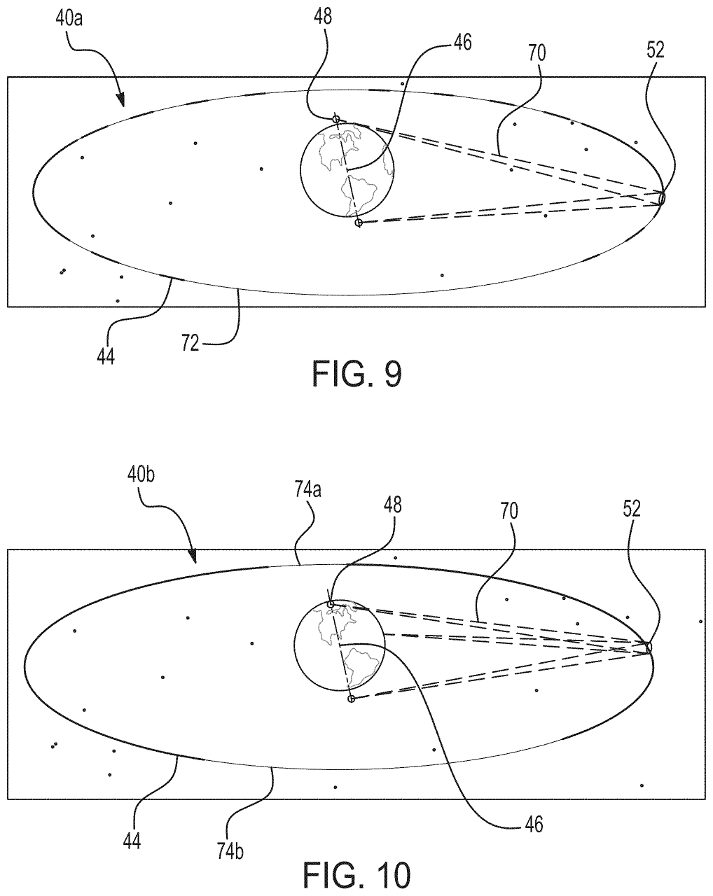

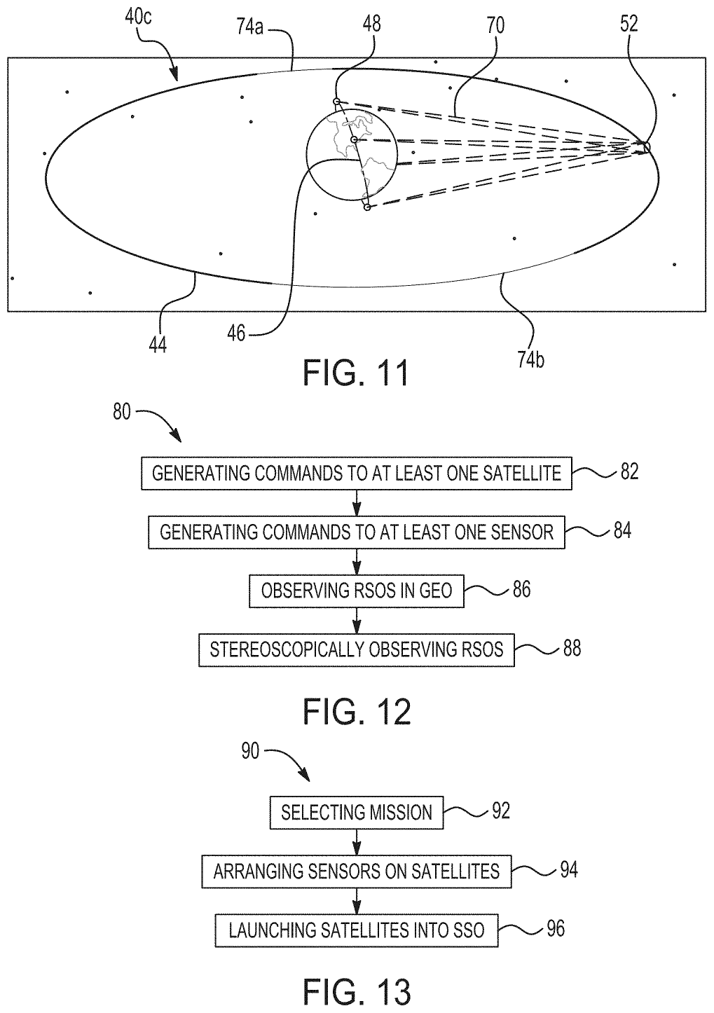

The percentage of coverage time for the GEO 44 may be considered to be monoscopic coverage or stereoscopic coverage, depending on the application for the SSA satellite system 40. For example, stereoscopic imaging or observation may occur if two SSA satellite sensors captures images of the RSO 52 at the same time. Monoscopic imaging or observation may occur using only one SSA satellite sensor. Any number of viewpoints may be suitable. For example, the SSA satellite system 40 may be configured to have between one and four SSA satellite views providing one or more viewpoints, as will be described further below (as shown in FIGS. 9, 10, and 11). For example, the stereo coverage of a two satellite SSA satellite system 40a configuration (shown in FIG. 9) can provide stereo coverage for over 50% of the RSOs 52 in GEO 44, a three satellite SSA satellite system 40b (shown in FIG. 10) can provide stereo coverage for 78% of the RSOs 52 in GEO 44, and a four satellite SSA satellite system 40c (shown in FIG. 11) can provide over 80% stereo coverage of the RSOs 52 in GEO 44.

The observation coverage of the RSOs 52 in GEO 44 may also be dependent on the time of year. For example, equinox conditions may be more stressful on the SSA satellite system 40 than solstice conditions due to the angle of the sun. In an exemplary application, during equinox, the SSA satellite system 40 may have approximately 63 percent monoscopic coverage of the RSO 52 in GEO 44, meaning that detection of RSOs 52 in GEO 44 occurs for 63 percent of the time in a day, using one SSA satellite 48. During solstice, the SSA satellite system 40 may have up to 76% coverage of RSOs 52 in GEO 44. In contrast, conventional satellite systems may have only 47% mono-coverage during equinox, and only 65% coverage during solstice. The SSA satellite system 40 provides 11% to 16% better coverage performance than the conventional systems.

The SSA satellite 48 may be inserted into the SSO 46 using any suitable commercially available launch vehicle that is able to accommodate the higher altitude of the SSA satellite system 40. A satellite configured for use in the SSA satellite system 40 may have a mass that is between 800 and 1000 kilograms. Exemplary existing launch vehicles that may be able to insert the SSA satellite 48 into the SSO 46 include Space X Falcon 9 Launch Vehicle, Polar Satellite Launch Vehicle (PSLV), and Arianespace Vega Launch vehicles. Many other launch vehicles may be suitable and the launch vehicle may be dependent on the application and configuration of the SSA satellite system 40.

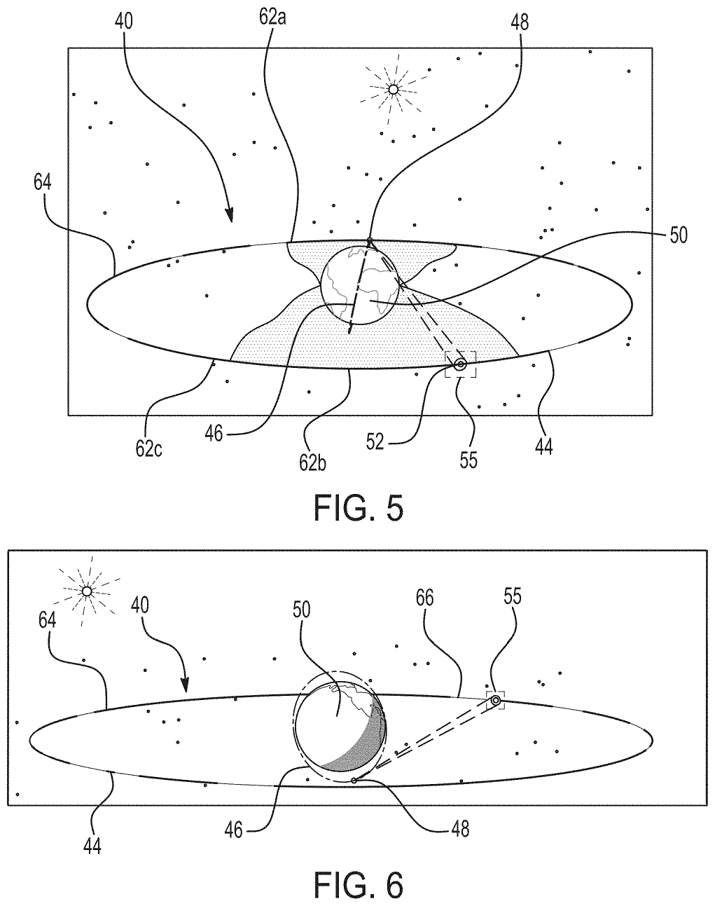

Referring now to FIGS. 5 and 6, an exemplary configuration of the SSA satellite system 40 for observing the RSO 52 is shown. The SSA satellite system 40 includes a visible sensor arranged on the SSA satellite 48 having a sun exclusion angle of 30 degrees, which could be significantly reduced by adding a sun shade to the sensor, and a minimum elevation of 100 kilometers, with an FOV 55 which is configured to view RSOs from LEO to MEO and GEO. The SSA satellite 48 may have an SSO which is a near polar circular orbit where the nodal precession rate of the orbit is the same or synchronized with the mean orbital rate of the Earth around the sun. The sun synchronous nodal precession rate is 0.9856 deg/day. This results in the orbital plane orientation with respect to the sun being constant over the mission life. The SSA orbit with 1500 km results in approximately 12.5 revolutions per day about the Earth 50. The SSA satellite system 40 includes the SSO 46 having the noon/midnight nodal crossing orbit, where the local mean solar time of passage for equatorial latitude is around noon or midnight and is arranged at an altitude of approximately 1500 kilometers, such that the altitude of the SSO 46 is below the peak radiation levels of the inner Van Allen belt. The orbit is circular and the degree of inclination of the SSO 46 is approximately 101.96 degrees. Equation (1) is used to determine the required nodal precession rate as a function of the orbital parameters:

$$\dot{Ω} = - \frac{3}{2} {{J}_{2} ( \frac{{a}_{e}}{a ( 1 - {e}^{2} )} )}^{2} n cos ( i ) \qquad ( 1 )$$

Equation (1) determines the nodal precession rate \dot{Ω} for SSOs, which is a fixed rate of 0.9856 deg/day. The variables in the equation are the orbital parameters, where a is the orbit semi major axis, e is the eccentricity which is set to zero for circular orbits, and i which is the orbital inclination. The other terms are constants, where aₑ is the equatorial radius of the Earth, and J₂ is the zonal harmonic coefficient. Equation (1) shows that for SSOs, the inclination needs to be greater than 90 degrees for the nodal regression rate to be posigrade. Equation (1) also shows that, for a constant nodal precession rate, as the semi major axis of the orbit increases, the inclination of the orbit will increase.

FIG. 5 shows the SSA satellite system 40 during an equinox season and FIG. 6 shows the SSA satellite system 40 during a solstice season. As shown in FIG. 5, the eclipse and sun exclusion regions 62a, 62b are the largest exclusion regions in the GEO 44. Some small Earth exclusion regions 62c may occur in the GEO 44 and these exclusion regions can be reduced by increasing altitude. As shown in FIG. 5, the target RSO 52 may be in the exclusion region 62a, rather than in a region of coverage 64 in the GEO 44. During the equinox, a percentage of monoscopic coverage of the RSO 52 in GEO 44 by the SSA satellite system 40 is approximately 63 percent.

As shown in FIG. 6, during the solstice season, the eclipse and sun exclusion regions are minimal due to the sun elevation angle with respect to the plane of the GEO 44. Some Earth exclusion regions 66 may occur. Accordingly, during the solstice, the percentage of coverage of the RSO 52 by the SSA satellite system 40 may be greater than during the equinox, due to the position of the sun. For example, a percentage of monoscopic coverage of the RSO 52 during the equinox may be approximately 76 percent.

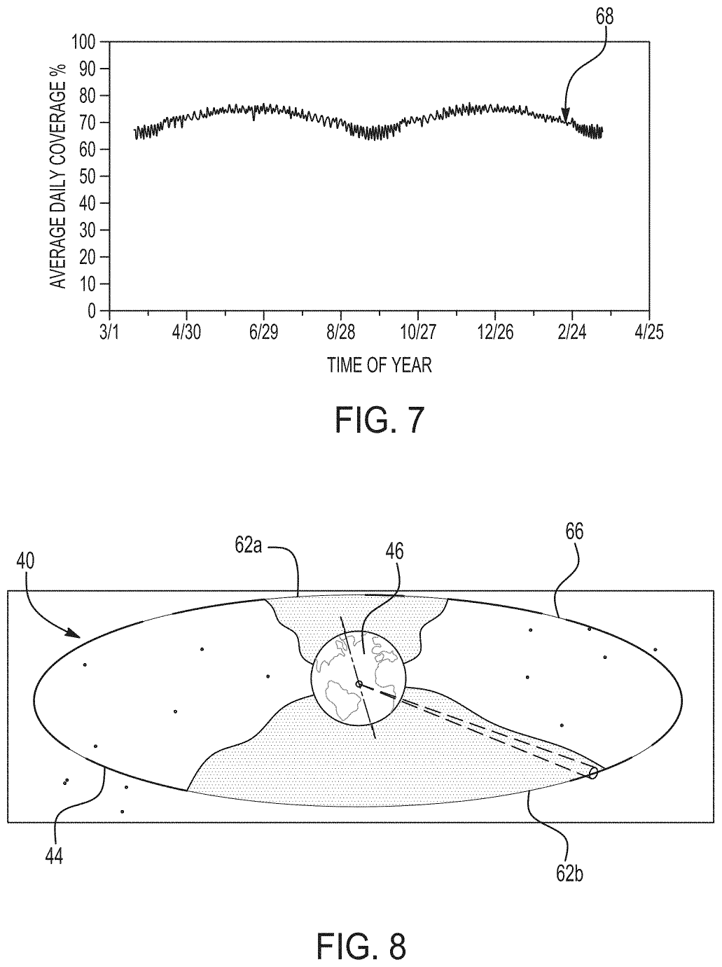

Referring in addition to FIG. 7, the average monoscopic daily coverage 68 for a single SSA satellite 48 in the SSO 46 having an altitude of 1500 km orbit is shown as a function of the time of year. The average daily coverage may vary from day to day over the course of the year due to the non-repeating nature of the SSO. The SSO 46 at 1500 km has approximately 12.5 revolutions per day resulting in a ground track that does not repeat from day to day.

In an exemplary embodiment, the SSO may have repeating ground tracks. These orbits have an integer number of revolutions per day and therefore have repeating ground tracks. For example, the SSO 46 may have an altitude of approximately 1680 km which has 12 revolutions per day resulting in a repeating ground track. The repeating ground track enables the SSA satellite 48 to pass over the same point on the Earth at the same time every day. This feature can be used to ensure the SSA satellite 48 passes over the ground station at the same time every day to provide daily communication with the ground station which may simplify the operations. The repeating ground track may also be beneficial to the SSA mission if the SSA includes an Earth imaging EOIR sensor which could provide Earth image data of an area of interest at the same time every day. Depending on the FOV of the imaging sensor, the system could view an area of interest multiple times a day.

FIG. 8 shows the SSA satellite system 40 having the same features as in FIGS. 5 and 6, but with the SSO 46 having an altitude of 2000 kilometers rather than 1500 kilometers. As shown in FIG. 8, some Earth exclusion regions 66a, 66b may occur in the GEO 44, and the eclipse and sun exclusion regions 62a, 62b are the largest exclusion regions during eclipse season. The SSA satellite system 40 having the altitude of 2000 kilometers has a monoscopic daily coverage of approximately 67 percent of RSOs in the GEO 44, such that the SSA satellite system 40 of FIG. 8 has slightly improved performance as compared with the SSA satellite system 40 having the altitude of the SSO 46 at 1500 kilometers. During an entire year for the SSA satellite system 40 having the altitude of 2000 kilometers, the average monoscopic daily observation coverage may have an average percentage of approximately 74 and range from 67 to 74.

Referring now to FIGS. 9-11, the SSA satellite system 40 configured for stereoscopic observation of the RSOs is shown, in comparison to the monoscopic observation of FIGS. 5, 6, and 8. FIG. 9 shows the SSA satellite system 40a having the RSO 52 in GEO 44 with two views 70 of the RSO 52 in GEO 44. FIG. 10 shows the SSA satellite system 40b having the RSO 52 in GEO 44 with three views 70 of the RSO in GEO 44. FIG. 11 shows the SSA satellite system 40c having the RSO 52 in GEO 44 with four views 70 of the RSO 52 in GEO 44. The SSA satellite system 40a, 40b, 40c in each of FIGS. 9-11 has the SSA satellite 48 with the sun synchronous noon/midnight orbit 46. The SSO 46 is arranged at 1500 kilometers with an inclination of 101.96 degrees, similar to the SSA satellite system 40 shown in FIGS. 5 and 6.

As shown in FIG. 9, two views 70 of the RSO 52 in GEO 44 may result in approximately 52% stereoscopic coverage of the RSO 52 in GEO 44. As shown in FIG. 10, three views 70 of the RSO 52 in GEO 44 may result in approximately 78% stereoscopic coverage of the RSO 52 in GEO 44. As shown in FIG. 11, four views 70 of the RSO 52 in GEO 44 may result in approximately 81% stereoscopic coverage of the RSO 52 in GEO 44.

Referring now to FIG. 12, a method 80 of observing RSOs using the SSA satellite system 40 (shown in FIGS. 3, 5, 6, 8, and 9-11) is shown. Step 82 of the method 80 includes generating commands to the SSA satellite 48 and step 84 includes generating commands to the sensor 54. The commands may be generated automatically, or by a user from a tracking station which may be ground-based or space-based. Step 82 may include generating commands to two or more SSA satellites 48 depending on the configuration of the SSA satellite system 40. Step 86 of the method 80 includes observing the RSOs 52 in the GEO 44, or other Earth orbits, having exclusion regions in which an Earth exclusion region is decreased or eliminated.

Step 86 of the method 80 may include eliminating the Earth exclusion region by combining the Earth exclusion region with an eclipse exclusion region in a same portion of the GEO 44 when the SSA satellite 48 is in a sunlight portion of the SSO 46 and combining the Earth exclusion region with the sun exclusion region in a same portion of the GEO 44 when the SSA satellite 48 is in an eclipse portion of the SSO 46. This step 86 may also include commands to rotate the sensor sun shield to minimize the sun exclusion zone. Eliminating the Earth exclusion region results in faster revisit rate for the RSOs 52 in GEO 44. Step 86 may further include detecting and/or imaging the RSOs 52 using a visible or infrared sensor. Observing the RSOs 52 may include monoscopically or stereoscopically observing or imaging the RSOs 52. For example, step 88 of the method 80 may include stereoscopically observing the RSOs 52 using more than one sensor view for over 40% of the time in a day. Observing the RSOs 52 may further include pointing at least one electro-optical and infrared imaging sensor at Earth, pointing at least one visible sensor at space, and performing SSA and Earth imaging with a repeating ground track with the SSO 46 having an altitude of 1680 kilometers.

Referring now to FIG. 13, a method 90 of forming a satellite system, such as the SSA satellite system 40 according to any of the embodiments described herein, is shown. Step 92 of the method 90 includes selecting a mission for the SSA satellite system 40. Step 94 of the method 90 includes arranging at least one sensor 54 or a sensor arrangement on the SSA satellite 48 as suitable for the mission. Any suitable sensor 54 may be used as required by the application for the SSA satellite system 40. Step 96 of the method 90 includes launching at least one SSA satellite 48 into the SSO 46 having the noon/midnight ascending node. Any suitable launch vehicle that is able to insert the SSA satellite 48 into the SSO 46 at an altitude that is between 1000 km and 2000 km may be used.

Although the disclosure shows and describes a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure. In addition, while a particular feature of the disclosure may have been described above with respect to only one or more of several illustrated embodiments, such feature may be combined with one or more other features of the other embodiments, as may be desired and advantageous for any given or particular application.

1. A satellite system comprising:
at least one satellite positioned in a sun synchronous orbit having a midnight or noon local time of ascending or descending node, or a local time of ascending or descending node that is within 45 degrees of midnight or noon, and an altitude that is between 1000 and 2000 kilometers; and
at least one sensor arranged on the at least one satellite and configured to observe resident space objects in an Earth orbit.

2. The satellite system according to claim 1, wherein the sun synchronous orbit has fewer than three main exclusion regions in which resident space objects are unobservable.

3. The satellite system according to claim 2, wherein the sun synchronous orbit has two main exclusion regions including an Earth/eclipse exclusion region in which an Earth exclusion region and an eclipse exclusion region are in a same portion of an Earth orbit belt when the at least one satellite is in a sunlight portion of the sun synchronous orbit, and an Earth/sun exclusion region in which the Earth exclusion region and a sun exclusion region are in a same portion of the Earth orbit belt when the at least one satellite is in an eclipse portion of the sun synchronous orbit.

4. The satellite system according to claim 1 further comprising two or more satellites.

5. The satellite system according to claim 4, wherein the two or more satellites have different altitudes that are between 1000 and 2000 kilometers.

6. The satellite system according to claim 1, wherein the altitude of the at least one satellite is 1680 kilometers whereby the satellite system is configured to have a repeating orbital ground track.

7. The satellite system according to claim 1, wherein an inclination of the sun synchronous orbit is greater than 90 degrees.

8. The satellite system according to claim 1, wherein a percentage of time in a day in which one of the resident space objects in the Earth orbit is monoscopically observed by the at least one satellite is greater than 63.

9. The satellite system according to claim 1, wherein the at least one satellite includes more than one satellite having a stereoscopic mode in which the more than one satellite has more than one viewpoint.

10. The satellite system according to claim 9, wherein a percentage of time in a day in which one of the resident space objects in the Earth orbit is stereoscopically observed by at least four satellites is greater than 80.

11. The satellite system according to claim 1, wherein the at least one sensor is a visible sensor and/or an infrared sensor.

12. The satellite system according to claim 11, wherein the at least one sensor includes a sun shield.

13. A method of observing resident space objects using a satellite system, the method comprising:
generating commands to at least one satellite positioned in a sun synchronous orbit having a midnight or noon local time of ascending or descending node, or a local time of ascending or descending node that is within 45 degrees of midnight or noon, and an altitude that is between 1000 and 2000 kilometers;
generating commands to a sensor arranged on the at least one satellite to selectively observe resident space objects in an Earth orbit.

14. The method according to claim 13 further comprising observing the resident space objects with the at least one satellite in the sun synchronous orbit having fewer than three main exclusion regions in which space objects are unobservable.

15. The method according to claim 14 further comprising eliminating an Earth exclusion region by combining the Earth exclusion region with an eclipse exclusion region in a same portion of an Earth orbit belt when the at least one satellite is in a sunlight portion of the sun synchronous orbit and combining the Earth exclusion region with a sun exclusion region in a same portion of the Earth orbit belt when the at least one satellite is in an eclipse portion of the sun synchronous orbit.

16. The method according to claim 14 further comprising increasing a revisit rate of the at least one satellite for one of the resident space objects.

17. The method according to claim 13 further comprising monoscopically observing the resident space objects in the Earth orbit for over 70% of time in a day.

18. The method according to claim 13 further comprising stereoscopically observing the resident space objects in the Earth orbit for over 80% of time in a day.

19. The method according to claim 13 further comprising
pointing at least one electro-optical and infrared imaging sensor at Earth;
pointing at least one visible sensor at space; and
performing situational space awareness and Earth imaging with a repeating ground track when the sun synchronous orbit has an altitude of 1680 kilometers.

20. A method of forming a satellite system, the method including:
arranging at least one sensor on at least one satellite to observe resident space objects in an Earth orbit; and
launching the at least one satellite into a sun synchronous orbit having a midnight or noon local time of ascending or descending node, or a local time of ascending or descending node that is within 45 degrees of midnight or noon, and an altitude that is between 1000 and 2000 kilometers, wherein the sun synchronous orbit has fewer than three main exclusion regions in which resident space objects are unobservable
